(19) United States
(12) Patent Application Publication
(10) Pub. No.: US 2018/0314347 A1
(43) Pub. Date: Nov. 1, 2018

(54) MODULAR ACTIVE PEN DESIGN AND AUTOMATIC FEATURE DISCOVERY METHOD

(71) Applicant: LENOVO (SINGAPORE) PTE. LTD., Singapore (SG)

(72) Inventors: Koji Kawakita, Tokyo (JP); Tatsumi Nagasawa, Tokyo (JP)

(73) Assignee: LENOVO (SINGAPORE) PTE. LTD., Singapore (SG)

(21) Appl. No.: 15/499,779

(22) Filed: Apr. 27, 2017

(51) Int. Cl. G06F 3/038; G06F 3/0354; G06F 3/041; G06Q 30/06

(52) U.S. Cl. CPC G06F 3/0383; G06F 3/03545; G06F 2203/04108; G06Q 30/0643; G06F 3/041

(57) ABSTRACT

Methods and apparatus are provided that can provide automatic feature discovery for modular active digitizer pens. A system is provided comprising a digitizer display; and a processor configured to: receive a human interface device (HID) transaction when a digitizer pen is in proximity to the digitizer display, wherein the digitizer pen comprises a pen body attached to a removable function module that supports a modular feature; extract a module identifier (ID) from the HID transaction, wherein the module ID is associated with the removable function module; and display, on the digitizer display, an informational message that concerns the modular feature, wherein the informational message is associated with the module ID. One or more applications compatible with the modular feature may be displayed, and one or more configuration tasks may be automatically executed to enable the modular feature on the system.

### BACKGROUND OF THE INVENTION

The present invention relates generally to methods and apparatus for managing digitizer pens. More particularly, the invention relates to systems and methods for providing automatic feature discovery for modular pens.

Touch sensitive displays and digitizer displays are fast becoming a standard component of modern personal computers, tablets, smartphones, and other devices. While a user can quickly select and manipulate on-screen items by touch, an active digitizer pen or stylus with a fine tip can provide a higher level of precision to support demanding professional and creative activities. A digitizer pen also feels natural to users who have been writing on pen and paper for much of their lives.

Since an active digitizer pen utilizes electrical power, many additional features can be integrated into the digitizer pen when compared to a passive digitizer pen. However, due to the compact pen-shaped form factor of the active digitizer pen, it is difficult to incorporate all possible features that a user may want in a single pen. Even when the digitizer pen incorporates a number of useful features, the user may not be aware of these features, or how to use these features, or which applications are compatible with these features.

As can be seen, there is a need for a system to improve the usability and feature discovery of digitizer pens.

### SUMMARY OF THE INVENTION

In one aspect of the present invention, a system is provided comprising a digitizer display; and a processor configured to: receive a human interface device (HID) transaction when a digitizer pen is in proximity to the digitizer display, wherein the digitizer pen comprises a pen body attached to a removable function module that supports a modular feature; extract a module identifier (ID) from the HID transaction, wherein the module ID is associated with the removable function module; and display, on the digitizer display, one or more applications based on the module ID, wherein the one or more applications include at least one application that is compatible with the modular feature.

In another aspect of the present invention, a method for providing automatic feature discovery for modular pens is provided, the method comprising: receiving a human interface device (HID) transaction when a digitizer pen is in proximity to a digitizer display, wherein the digitizer pen comprises a pen body attached to a removable function module that supports a modular feature; extracting a module identifier (ID) from the HID transaction, wherein the module ID is associated with the removable function module; and displaying, on the digitizer display, an informational message that concerns the modular feature, wherein the informational message is associated with the module ID.

In still another aspect of the present invention, a non-transitory computer readable media containing computer readable instructions is provided. When executed by one or more processors of a system, the computer readable instructions cause: receiving a human interface device (HID) transaction when a digitizer pen is in proximity to a digitizer display of the system, wherein the digitizer pen comprises a pen body attached to a removable function module that supports a modular feature; extracting a module identifier (ID) from the HID transaction, wherein the module ID is associated with the removable function module; and performing one or more configuration tasks based on the module ID to configure the system to support the modular feature.

These and other features, aspects and advantages of the present invention will become better understood with reference to the following drawings, description and claims.

### BRIEF DESCRIPTION OF THE DRAWINGS

FIG. 1A is schematic block diagram of a system that provides automatic feature discovery for modular pens, in accordance with an exemplary embodiment of the invention;

FIG. 1B is a schematic block diagram of exemplary pen bases and removable function modules that can be combined into a modular pen, in accordance with an exemplary embodiment of the invention;

FIG. 2A and FIG. 2B is an exemplary depiction of a user interface of a system that provides automatic feature discovery for modular pens, in accordance with an exemplary embodiment of the invention; and

FIG. 3 is a flow chart of a method for providing automatic feature discovery for modular pens in accordance with an exemplary embodiment of the invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

The present invention relates generally to methods and apparatus for managing digitizer pens. More particularly, the invention relates to systems and methods for providing automatic feature discovery for modular pens.

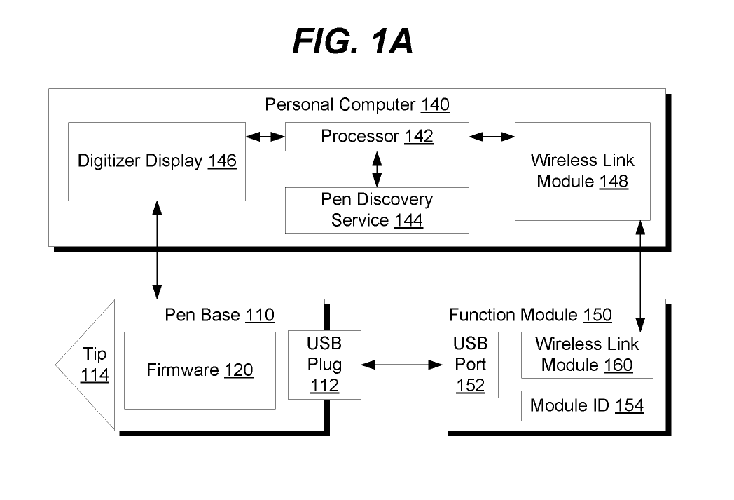

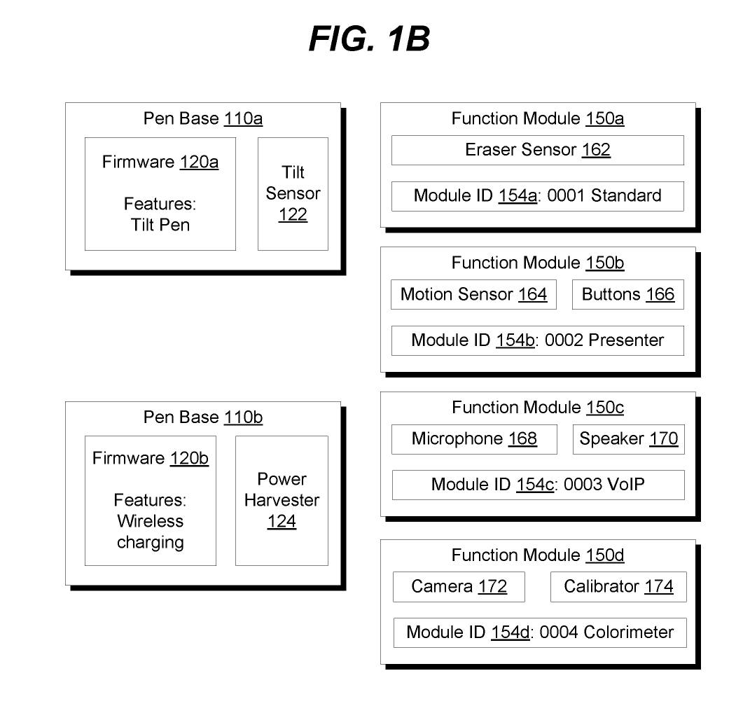

Referring now to FIG. 1A, a schematic block diagram of a system that provides automatic feature discovery for modular pens is shown. FIG. 1A includes pen base 110, function module 150, and personal computer 140. Pen base 110 may include USB plug 112, tip 114, and firmware 120. Personal computer 140 may comprise a portable computer such as a laptop, tablet, hybrid convertible, or other form factor. Personal computer 140 may include processor 142, pen discovery service 144, digitizer display 146, and wireless link module 148. Processor 142 may comprise one or more general purpose or customized processors, such as but not limited to an ASIC, FPGA, SoC, or other IC. Function module 150 may include USB port 152, module ID 154, and wireless link module 160. For simplicity, only a single pen base 110 and function module 150 are depicted; however, it should be understood that personal computer 140 may support multiple digitizer pens.

As shown in FIG. 1A, personal computer 140 may execute pen discovery service 144 using processor 142. For example, pen discovery service 144 may correspond to a service or daemon that is loaded upon the startup of an operating system, and may be preinstalled onto personal computer 140. Pen base 110 may correspond to the tip and main body of an active digitizer pen. As shown in FIG. 1A, pen base 110 is attached to function module 150 via USB plug 112. USB plug 112 may, for example, comprise a USB Type C plug, and may connect to any powered USB Type C port for recharging the active digitizer pen. When pen base 110 is connected to function module 150, which may correspond to the end portion of an active digitizer pen, then a single uniform pen body may be formed. When the user wants to recharge the pen or connect to a different function module, the user can detach function module 150. To provide additional security from accidental disconnections, USB plug 112 and USB port 152 may connect using magnetic assistance or by using a mechanical latch or other securing means.

Since pen base 110 may only connect to personal computer 140 via USB plug 112 when the user wishes to recharge the pen, an alternative communications channel may be necessary, for example if function module 150 provides features that require data communications with personal computer 140. In this case, function module 150 may be provided with a communications module, such as wireless link module 160, which can synchronize and communicate with a respective communications module of personal computer 140, or wireless link module 148. In an embodiment, wireless link modules 148 and 160 may utilize Bluetooth, NFC, Wi-Fi, or any other suitable communications protocol.

To begin, the user may first bring tip 114 into proximity with digitizer display 146. Note that the term “proximity” here can mean that tip 114 is not only close to, but also touching, digitizer display 146. In certain embodiments, “proximity” may mean that tip 114 is exerting detectable pen pressure on digitizer display 146. In response, firmware 120 may generate messages in conjunction with digitizer display 146 to provide position, pen pressure, button states, tilt angle (if available), features, identifiers, and other data of pen base 110 and function module 150. These messages may be received as human interface device (HID) transactions by a tablet digitizer driver of personal computer 140.

Pen discovery service 144 may intercept and read these HID transactions to determine the features of pen base 110 and function module 150. For example, firmware 120 may retrieve module ID 154 from function module 150 and embed module ID 154 into the HID transactions. Firmware 120 may also embed identifiers into the HID transactions that concern the features of pen base 110. Based on these identifiers, pen discovery service 144 can perform configuration tasks to enable the features of pen base 110 and function module 150 to operate on personal computer 140. Further, based on these identifiers, pen discovery service 144 may display, on digitizer display 146, informational messages concerning associated pen features and applications that support those pen features.

To provide examples of the various pen features that can be supported, referring to FIG. 1B, a schematic block diagram of exemplary pen bases and removable function modules that can be combined into a modular pen is shown. FIG. 1B includes pen base 110a, pen base 110b, function module 150a, function module 150b, function module 150c, and function module 150d. Pen base 110a may include firmware 120a and tilt sensor 122. Pen base 110b may include firmware 120b and power harvester 124. Function module 150a may include eraser sensor 162 and module ID 154a. Function module 150b may include motion sensor 164, buttons 166, and module ID 154b. Function module 150c may include microphone 168, speaker 170, and module ID 154c. Function module 150d may include camera 172, calibrator 174, and module ID 154d. With respect to FIG. 1B, like numbered elements may correspond to the same elements from FIG. 1A. While not specifically shown in FIG. 1B, pen base 110a-110b may each include a tip and USB plug, and function module 150a-150d may each include a USB port and a wireless link module.

As shown in FIG. 1B, a variety of pen bases may be available to select according to the user's needs. Firmware 120a and firmware 120b may each identify the particular features of respective pen base 110a and pen base 110b. Pen base 110a may be an option for users that need more drawing precision, adding tilt sensitivity via tilt sensor 122 so that brush strokes can be drawn integrating pen tilt. If the user does not require such precise drawing features, then the user might instead opt for pen base 110b, which provides wireless charging through power harvester 124. If the user's needs change, then the user can easily upgrade or switch to a different pen base.

Once the user selects a pen base, a variety of function modules may be attached to provide the features that the user desires. As shown in FIG. 1B, four example function modules are illustrated: a “Standard” function module 150a that provides an eraser function, a “Presenter” function module 150b that provides mouse pointer movement and navigation buttons, a “VoIP” function module 150c that enables voice communication, and a “Colorimeter” function module 150d that allows the user to color calibrate a display. Since each pen base and function module only needs to implement specific functions rather than all possible functions, system designers are advantageously enabled to provide designs that efficiently utilize all of the limited space that is available.

Function module 150a may be provided as a standard option, with an eraser sensor 162 that allows the user to flip the pen and erase. In this case, function module 150a may omit a wireless link module since the eraser state may be transmitted via the HID transactions generated by pen base 110a. Module ID 154a identifies function module 150a as module ID 0001, corresponding to a “Standard” module. While a four digit numeric code is used as an example, any suitable identifier format may be utilized.

Function module 150b may be focused on providing presentation features, and may thus provide air mouse capability via motion sensor 164. Thus, even if the digitizer pen is not in proximity of the digitizer display, the user can simply wave the digitizer pen in the air to move a mouse pointer and navigate. Additional buttons 166 may allow the user to move forwards and backwards, for example to navigate through slides of a presentation. Since the additional input functionality may require separate driver support, a wireless link module may be provided in function module 150b. For example, function module 150b may be detected as a standard or custom human interface device (HID) via a wireless link module utilizing a Bluetooth protocol.

Function module 150c provides voice communication features, allowing the user to conduct voice calls over VoIP, for example. Thus, pen discovery service 144 may perform several configuration tasks, such as installing a wireless audio driver to allow microphone 168 and speaker 170 to function on personal computer 140, and switching a default recording and playback device to microphone 168 and speaker 170, respectively.

Function module 150d provides color calibration features, allowing the user to calibrate digitizer display 146. Thus, pen discovery service 144 may perform several configuration tasks, such as installing a wireless video capture driver to allow camera 172 to function on personal computer 140. Calibrator 174 may then perform a calibration procedure by using camera 172 to capture test patterns shown on digitizer display 146 and generating a corresponding color profile for a specific calibration target.

As discussed above in conjunction with FIG. 1A, pen discovery service 144 can perform configuration tasks to enable the features of the digitizer pen to operate on personal computer 140. To provide an example, assume that the user has just purchased function module 150b, and attached it to pen base 110b to form a modular pen. Once the user places the tip of the modular pen in proximity to digitizer display 146, firmware 120b causes module ID 154b to be embedded into a HID transaction. Pen discovery service 144 may intercept this HID transaction and extract module ID 154b as module ID 0002. This module ID may be matched to a specific entry in a lookup table or database to identify the specific features and functions of the module, or “Presenter” for module ID 0002. The entry may include, for example, references to one or more device drivers, configuration scripts, informational messages, and other data.

With function module 150b now identified, pen discovery service 144 can, for example, install a corresponding Bluetooth air mouse driver and further perform an automatic Bluetooth pairing with function module 150b. One or more compatible applications may also be installed. Thus, the user merely needs to approach digitizer display 146 with the modular pen and any necessary configuration tasks are carried out automatically. Advantageously, the user can avoid several time consuming and error prone tasks, including, but not limited to finding and installing correct and up-to-date drivers for personal computer 140, performing a wireless synchronization with functional module 150b including PIN code entry, and finding and downloading compatible applications. Further, digitizer display 146 may display informational messages to guide the user to make the most of the available features, thereby facilitating feature discovery.

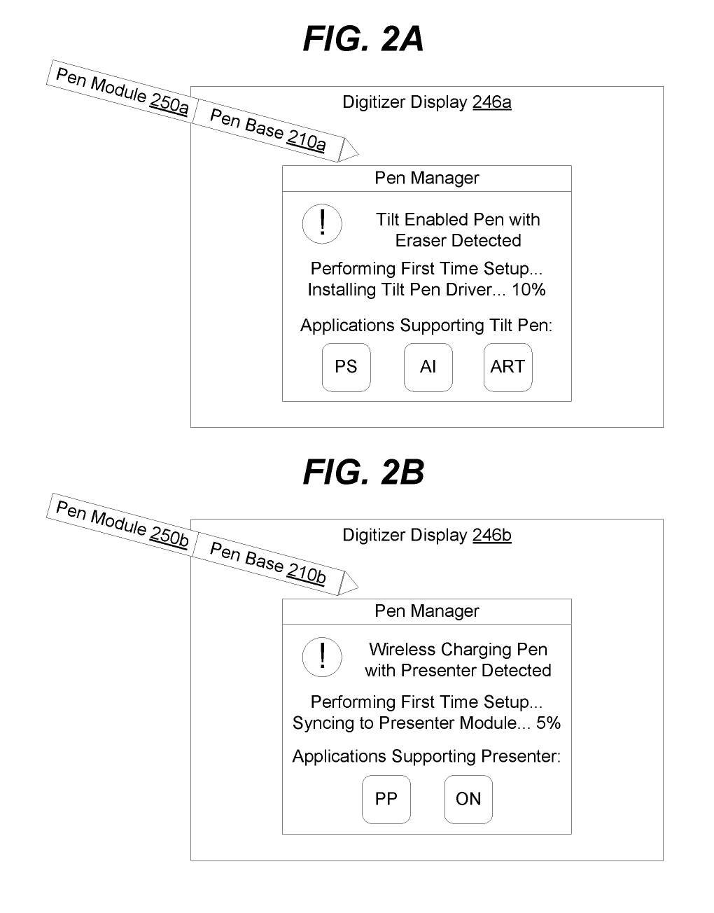

To provide examples of the informational messages that pen discovery service 144 may present to the user, FIG. 2A and FIG. 2B is an exemplary depiction of a user interface of a system that provides automatic feature discovery for modular pens. FIG. 2A includes pen base 210a, pen module 250a, and digitizer display 246a. With respect to FIG. 2A, like numbered elements may correspond to the same elements from FIG. 1A and FIG. 1B.

First, the user may approach digitizer display 246a with a modular pen comprising pen base 210a attached to pen module 250a. Referring to FIG. 2A and FIG. 1A, once the modular pen comes into proximity with digitizer display 246a, pen discovery service 144 may detect a tilt enabled pen base 210a that provides a standard eraser function in pen module 250a. Pen discovery service 144 may then provide a notification on digitizer display 246a that a modular pen has been detected, for example by blinking a system tray icon or providing some other alert. In response, the user may click on the icon to bring up the pen manager window as shown in FIG. 2A. In some embodiments, the pen manager window may appear automatically, or may appear automatically only for an initial detection of the modular pen.

As shown in digitizer display 246a, the user interface shows informational messages that identify features of the modular pen, or a “Tilt Enabled Pen with Eraser”. Providing support for tilt detection may require a specific driver to be installed or specific system settings to be changed, which can be automatically carried out by pen discovery service 144. Further, to guide the user to make the most of the modular pen's features, one or more applications may be presented to the user, which are shown as icons in FIG. 2A. In response to a user input, for example by clicking on an icon, a corresponding application may be executed on personal computer 140, wherein the application is compatible with the pen feature, or tilt functionality in this example. If the user does not currently have the application installed, then the user may be redirected to a storefront page enabling the user to purchase the application. Besides feature compatibility, other factors may be utilized to determine the specific applications that are shown to the user, providing opportunities for developer partnerships.

FIG. 2B illustrates another example user interface and includes pen base 210b, pen module 250b, and digitizer display 246b. With respect to FIG. 2B, like numbered elements may correspond to the same elements from FIG. 1A and FIG. 1B.

In a process similar to that described above with FIG. 2A, pen discovery service 144 may identify pen base 210b as supporting wireless charging, and pen module 250b as a function module supporting presentation functions. Thus, digitizer display 246b displays an informational message that a “Wireless Charging Pen with Presenter” is detected, performs configuration tasks such as installing a wireless pointer driver and performing a wireless synchronization with pen module 250b, and displays one or more applications compatible with the detected pen features, or the presenter features of pen module 250b. In this manner, the features of the modular pen are clearly identified for the user, any necessary configuration changes to enable the features on personal computer 140 are carried out automatically, and the user can begin using those features right away by selecting a displayed compatible application.

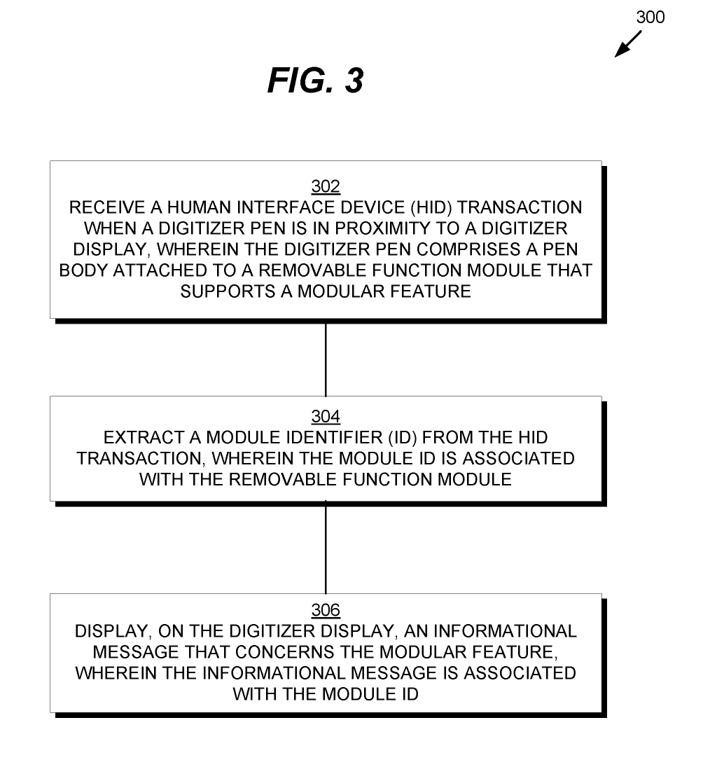

Referring now to FIG. 3, a flow chart illustrates a method 300 for providing automatic feature discovery for modular pens. In block 302, referring to FIG. 1A, processor 142 receives a human interface device (HID) transaction when a digitizer pen is in proximity to digitizer display 146, wherein the digitizer pen comprises pen base 110 attached to function module 150 that supports a modular feature. As illustrated in FIG. 1B, this modular feature can be a pen eraser, a presenter remote, a VoIP microphone, a colorimeter, or any other feature. The HID transaction may be triggered by a tablet digitizer driver when tip 114 is within detectable range of digitizer display 146, which may not necessarily touch digitizer display 146. However, in some embodiments, proximity to digitizer display 146 may be defined as exerting some threshold pen pressure onto digitizer display 146.

In block 304, referring to FIG. 1A, processor 142 extracts module identifier (ID) 154 from the HID transaction, wherein module ID 154 is associated with function module 150. As discussed above, firmware 120 may retrieve module ID 154 from function module 150 and cause module ID 154 to be embedded in the HID transaction. In turn, pen discovery service 144 can intercept the HID transaction and extract module ID 154, which is associated with function module 150. As discussed above, pen discovery service 144 may be running as a background service or daemon on processor 142.

In block 306, referring to FIG. 1A, processor 142 displays, on digitizer display 146, an informational message that concerns the modular feature, wherein the informational message is associated with module ID 154. Thus, pen discovery service 144 may generate a user interface that is displayed on digitizer display 146. For example, as discussed above, the informational message may be a field in a lookup table or a database entry that is associated with module ID 154. The informational message may, for example, correspond to “Presenter detected” when function module 150b is connected, as shown in FIG. 2B. Additionally, the informational message may include one or more applications that are compatible with the feature, as illustrated in FIG. 2A-2B. Besides the modular features of the removable function module, the informational message may also concern the base features of the pen base, as illustrated by “Tilt Enabled Pen” and “Wireless Charging Pen” in FIG. 2A-2B.

Besides displaying information messages with compatible applications, processor 142 may perform one or more configuration tasks to enable the modular feature on personal computer 140. As discussed in the above examples, these configuration tasks may include installing a driver to enable the modular feature on the system, performing a wireless pairing with the digitizer pen, and installing an application that is compatible with the modular feature. These configuration tasks may also apply for base features of pen base 110.

It should be understood that method 300 may be implemented as computer readable instructions that are provided on non-transitory computer readable media, such as a hard disk drive, flash memory, an optical disc, or other media. When executed by one or more processors, the instructions may cause method 300 to be carried out.

It should be understood, of course, that the foregoing relates to exemplary embodiments of the invention and that modifications may be made without departing from the spirit and scope of the invention as set forth in the following claims.

We claim:

1. A system comprising:
a digitizer display; and
a processor configured to:
receive a human interface device (HID) transaction when a digitizer pen is in proximity to the digitizer display, wherein the digitizer pen comprises a pen body attached to a removable function module that supports a modular feature;
extract a module identifier (ID) from the HID transaction, wherein the module ID is associated with the removable function module; and
display, on the digitizer display, one or more applications based on the module ID, wherein the one or more applications include at least one application that is compatible with the modular feature.

2. The system of claim 1, wherein the one or more applications further include at least one application that is compatible with a base feature of the pen body.

3. The system of claim 1, wherein the processor is further configured to:
perform one or more configuration tasks including at least one of: installing a driver to enable the modular feature on the system, performing a wireless pairing with the digitizer pen, and installing an application that is compatible with the modular feature.

4. The system of claim 1, wherein the processor is further configured to:
in response to a user input, execute a particular application of the one or more applications.

5. The system of claim 1, wherein the processor is further configured to:
display, on the digitizer display, a storefront page enabling a user to purchase a particular application of the one or more applications.

6. The system of claim 1, wherein the modular feature comprises one of a pen eraser, a presenter remote, a voice over IP (VoIP) microphone, and a colorimeter.

7. The system of claim 1, wherein prior to the receiving of the HID transaction, the pen body retrieves the module ID from the removable function module and embeds the module ID in the HID transaction.

8. A method for providing automatic feature discovery for modular pens, the method comprising:
receiving a human interface device (HID) transaction when a digitizer pen is in proximity to a digitizer display, wherein the digitizer pen comprises a pen body attached to a removable function module that supports a modular feature;
extracting a module identifier (ID) from the HID transaction, wherein the module ID is associated with the removable function module; and
displaying, on the digitizer display, an informational message that concerns the modular feature, wherein the informational message is associated with the module ID;
wherein the method is performed by one or more processors.

9. The method of claim 8, wherein the informational message includes one or more applications that are compatible with the modular feature.

10. The method of claim 8, wherein the informational message further concerns a base feature of the pen body, and wherein the informational message includes one or more applications that are compatible with the base feature.

11. The method of claim 8, further comprising:
performing one or more configuration tasks including at least one of: installing a driver to enable the modular feature on the system, performing a wireless pairing with the digitizer pen, and installing an application that is compatible with the modular feature.

12. The method of claim 8, wherein the modular feature comprises one of a pen eraser, a presenter remote, a voice over IP (VoIP) microphone, and a colorimeter.

13. The method of claim 8, wherein prior to the receiving of the HID transaction, the method further comprises:
retrieving, by the pen body, the module ID from the removable function module; and
embedding, by the pen body, the module ID in the HID transaction.

14. A non-transitory computer readable media containing computer readable instructions that, when executed by one or more processors of a system, causes:
receiving a human interface device (HID) transaction when a digitizer pen is in proximity to a digitizer display of the system, wherein the digitizer pen comprises a pen body attached to a removable function module that supports a modular feature;
extracting a module identifier (ID) from the HID transaction, wherein the module ID is associated with the removable function module; and
performing one or more configuration tasks based on the module ID to configure the system to support the modular feature.

15. The non-transitory computer readable media of claim 14, wherein the instructions, when executed by the one or more processors of the system, further cause:
displaying, on the digitizer display, one or more applications based on the module ID, wherein the one or more applications include at least one application that is compatible with the modular feature.

16. The non-transitory computer readable media of claim 14, wherein the instructions, when executed by the one or more processors of the system, further cause:
displaying, on the digitizer display, one or more applications that are compatible with a base feature of the pen body.

17. The non-transitory computer readable media of claim 14, wherein the one or more configuration tasks include at least one of: installing a driver to enable the modular feature on the system, performing a wireless pairing with the digitizer pen, and installing an application that is compatible with the modular feature.

18. The non-transitory computer readable media of claim 14, wherein the instructions, when executed by the one or more processors of the system, further cause:
in response to a user input, executing an application that is compatible with the modular feature.

19. The non-transitory computer readable media of claim 14, wherein the modular feature comprises one of a pen eraser, a presenter remote, a voice over IP (VoIP) microphone, and a colorimeter.

20. The non-transitory computer readable media of claim 14, wherein prior to the receiving of the HID transaction, the pen body retrieves the module ID from the removable function module and embeds the module ID in the HID transaction.
